(19) United States
(12) Patent Application Publication
(10) Pub. No.: US 2020/0215854 A1
(43) Pub. Date: Jul. 9, 2020

(54) PetraGel

(71) Applicant: Crystal Sylver, San Francisco, CA (US)

(72) Inventor: Crystal Sylver, San Francisco, CA (US)

(21) Appl. No.: 16/244,008

(22) Filed: Jan. 9, 2019

(51) Int. Cl. B60C 1/00; B60C 7/00

(52) U.S. Cl. CPC B60C 1/00; B60C 2001/0091; B60C 7/00

(57) ABSTRACT

The invention is a solid ‘green’ tire.

### CROSS-REFERENCE TO RELATED APPLICATIONS

Provisional Patent Filed Jan. 11, 2018 Application No. 62/709,206

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF INVENTION

PetraGel is a manufactured article and chemical composition. It is a solid bio-waste tire that is meant to last the lifetime of the vehicle.

Traditional tires are made of rubber, fabric, and metal, making them non-recyclable and toxic for the environment. They require air maintenance otherwise they will deflate. They also have a minimal tread life and must be replaced often, if not they cause blowouts and flat tires, which lead to accidents on the road.

Traditional rubber tires leach toxins into the environment and are one of the most problematic sources of waste in landfills. Tires in landfills have potential for fires and are not extinguishable, can burn for several weeks, and produce very harmful acid smoke. Tire stockpiles create great health and safety risks, worker injury, and even death due to the amount of negative space they use.

### BRIEF SUMMARY OF INVENTION

PetraGel offers customers a solid tire that is designed to last the lifetime of the automobile, big-rig, motorcycle, bicycle, or aircraft. A tire that does not require air maintenance. A tire that does not use rubber that erodes and ages, eliminating rotating and replacement of tires. A tire that can be repaired, reused, recycled.

PetraGel is recyclable and made of biowaste material, which also helps to minimize landfill tire waste and toxins in the environment. Over 300 million rubber car tires are disposed of in landfills each year in the USA.

PetraGel tires save consumers money, are safer on the road, and healthier for the environment, creating a green tire.

### BRIEF DESCRIPTION OF THE SEVERAL VIEWS OF THE DRAWING

1/1 FIG. 1—Front view of PetraGel,

FIG. 2—Side view of PetraGel

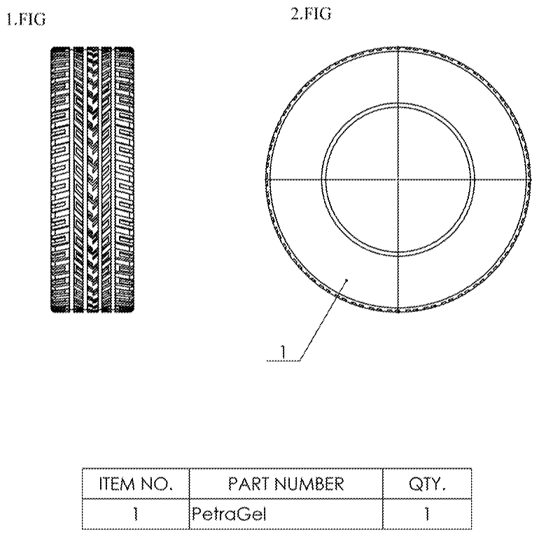

1. PetraGel

(1) PetraGel tire

### DETAILED DESCRIPTION OF THE INVENTION

PetraGel is made of a petroleum jelly or petroleum byproduct and crystal polymer, creating a solid tire. The tire tread is part of the mold and will last the lifetime of the car. The petroleum gel gives the tire a light give. It is made of biowaste material from oil refining industries. It can be made of vegetable oils, motor oils, recycled oils, etc. Energy efficient green tires will be in higher demand as the global market shifts towards reducing greenhouse gases and pollutions in the environment.

Highly dispersible silica may be used to improve the performance of the tire by reducing the rolling resistance and improving grip.

PetraGel can be used for automobile tires, racecar tires, big-rig tires, bicycle tires, moped and motorcycle tires, and aircraft tires.

PetraGel can be designed in all shapes and sizes with the tread being designed in various ways, creating the safest tire. The tread may also be thicker than average rubber tire tread.

PetraGel is used and manufactured in a similar manner as traditional rubber tires. A manufacturing plant making rubber tires could also make PetraGel tires.

PetraGel greatly improves upon the current model of tire being used around the world today. It is designed to last the lifetime of the automobile, 30+ years. It can be repaired rather than thrown in the landfill. It can withstand pressures that rubber tires cannot. It can be made as a fire resistant tire. It can be repaired, reused, and recycled. It reduces and eliminates toxins and pollutions in the environment. It saves consumers money. It does not require air to maintain effectiveness.

1. The invention claimed is a PetraGel tire comprised of:
Petroleum jelly and crystal polymer molded to form a solid tire with a tread on the driving surface.

2. The PetraGel tire as recited in claim 1, may use petroleum jelly or any petroleum byproduct.

3. The PetraGel tire as recited in claim 1, may use any ratio for the chemical composition to create appropriate give and strength of the tire.

4. The PetraGel tire as recited in claim 1, may use crystal polymer in any form or any chemical compound used as a hardening agent.

5. The PetraGel tire as recited in claim 1, may use a variety of tread mark styles.

6. The PetraGel tire as recited in claim 1, may be made for any automobile, big-rig, racecar, motorcycle, moped, bicycle, aircraft, or other.

7. The PetraGel tire as recited in claim 1, may be made into any shape or size.

8. The PetraGel tire as recited in claim 1, may use highly dispersible silica for added safety.

9. The PetraGel tire as recited in claim 1, may be any variation in color.

10. The PetraGel tire as recited in claim 1, may use any thickness for the tread.

11. The PetraGel tire as recited in claim 1, may be designed as fire resistant.

12. The PetraGel tire as recited in claim 1, may use a fire resistant coating or sealer.
